(19) United States
(12) Patent Application Publication
(10) Pub. No.: US 2020/0398524 A1
(43) Pub. Date: Dec. 24, 2020

(54) FIBER-REINFORCED THERMOPLASTIC RESIN FORMING MATERIAL

(71) Applicant: Toray Industries, Inc., Tokyo (JP)

(72) Inventors: Satoshi Seike, Nagoya (JP); Masaru Tateyama, Nagoya (JP); Mitsuki Fuse, Nagoya (JP)

(21) Appl. No.: 16/957,297

(22) PCT Filed: Dec. 12, 2018
(86) PCT No.: PCT/JP2018/045650

§ 371 Date: Jun. 23, 2020

(30) Foreign Application Priority Data
Dec. 26, 2017 (JP) 2017-249456

(51) Int. Cl. B32B 5/26

(52) U.S. Cl. CPC B32B 5/26; B32B 2605/00; B32B 2262/106; B32B 2262/101

(57) ABSTRACT

A fiber-reinforced thermoplastic resin forming material contains reinforcing fiber bundles in a thermoplastic resin, wherein a first component (I) and a second component (II) are laminated in such a manner that the first component (I) is arranged in the surface of the forming material. The fiber-reinforced thermoplastic resin forming material has excellent mechanical properties and excellent formability into a complicated shape. The first component (I): a sheet-like material having a heat conductivity (λ1) of 0.2 W/m·K or less; and the second component (II): a fiber-reinforced thermoplastic resin sheet-like material having a product (B2) of a density and a specific heat of 1.7×10⁶ J/m³·K or more.

### TECHNICAL FIELD

This disclosure relates to a fiber-reinforced thermoplastic resin forming material excellent in mechanical properties and formability of complicated shapes.

### BACKGROUND

Carbon fiber-reinforced plastics (CFRP), excellent in specific strength and specific rigidity, have actively been developed for automotive materials recently.

Such materials applied to automobiles include a prepreg and a material made of thermosetting resin used for airplanes and sport gear by resin transfer molding (RTM) or filament winding (FW). On the other hand, CFRP made from thermoplastic resin can be formed at high speed molding and excellent recycling efficiency so that they are expected to be a material suitable for mass production. Press forming can form a complicated shape of a large area with resin at a high productivity, and is expected to take the place of metal forming processes.

Press forming is mostly performed with a sheet-shaped material made of discontinuous reinforcing fiber as an intermediate base material. The sheet-shaped materials typically include sheet molding compound (SMC) and glass mat thermoplastic (GMT) as disclosed in JP 2000-141502-A and JP 2003-80519-A. Both of those intermediate base materials, which are used for so-called “Flow Stamping Forming” to charge the die cavity with material flowing inside, comprise relatively long reinforcing fibers dispersed like chopped strands and/or swirls in the thermoplastic resin. Such materials comprising fiber bundles consisting of many single yarns may have poor mechanical properties of shaped product in spite of excellent fluidity during a forming process.

JP 2014-28510-A discloses an intermediate base material for press forming made by alternately laminating thermoplastic resin components (I) and (II) comprising discontinuous reinforcing fibers dispersed like monofilaments. JP H6-47737-A discloses a reinforced stampable sheet for press forming made by laminating continuous glass fiber sheets and short glass fiber sheets comprising thermoplastic resin matrix. Both of them have a poor fluidity although being excellent in mechanical properties.

JP 5985085-B discloses a forming material having a multi-layer structure consisting of sheets different in fiber length and density parameter. The mechanical properties are enhanced by using long fibers in the surface layer sheet while fluidity is enhanced by using short fibers in the inner layer sheet. JP 5843048-B discloses a forming material consisting of skin layer and core layer having different mat structures. The mechanical properties and fluidity are enhanced by using less thermally conductive reinforcing fibers in the skin layer and carbon fibers in the core layer. Although the balance between mechanical properties and fluidity have been improved, they are demanded to improve further.

It could therefore be helpful to provide a fiber-reinforced thermoplastic resin forming material excellent in mechanical properties and fluidity during a forming process.

### SUMMARY

We thus provide:

[1] A fiber-reinforced thermoplastic resin forming material that contains reinforcing fiber bundles in a thermoplastic resin, wherein a laminate of a first component (I) and a second component (II) has a surface layer of the first component (I), the first component (I) being a sheet having a thermal conductivity (λ1) of 0.2 W/m·K or less, the second component (II) being a fiber-reinforced thermoplastic resin sheet having a product (B2) of a density and a specific heat of 1.7×10⁶ J/m³·K or more.
[2] The fiber-reinforced thermoplastic resin forming material according to the preceding item, wherein the first component (I) has a void ratio of 5% or more.
[3] The fiber-reinforced thermoplastic resin forming material according to the preceding items, wherein the reinforcing fiber bundles have a cutting angle (θ) of 3° or more and 30° or less.
[4] The fiber-reinforced thermoplastic resin forming material according to the preceding items, wherein the reinforcing fiber bundles have an aspect ratio (A2) of 10 or less in the second component (II).
[5] The fiber-reinforced thermoplastic resin forming material according to the preceding items, wherein the first component (I) has a fiber weight content (Wf1) of 20 wt % or more.
[6] The fiber-reinforced thermoplastic resin forming material according to the preceding items, wherein the second component (II) has a proportion of 50 to 95 vol % with respect to a total volume of the first component (I) and the second component (II).
[7] The fiber-reinforced thermoplastic resin forming material according to the preceding items, wherein the reinforcing fiber bundles have an average fiber length (Lf1) of 8 mm or more and 100 mm or less in the first component (I).
[8] The fiber-reinforced thermoplastic resin forming material according to the preceding items, wherein the reinforcing fiber bundles have an average fiber length (Lf2) of 3 mm or more and 20 mm or less in the second component (II).
[9] The fiber-reinforced thermoplastic resin forming material according to the preceding items, wherein the second component (II) has a fiber weight content (Wf2) of 50 wt % or less.
[10] The fiber-reinforced thermoplastic resin forming material according to the preceding items, wherein the reinforcing fiber bundles have an average fiber number (n2) of 500 or more in the second component (II).
[11] The fiber-reinforced thermoplastic resin forming material according to the preceding items, wherein the laminate of the first component (I) and the second component (II) has a laminate structure of [(I)/(II)ₘ/(I)], where m is a positive integer.
[12] The fiber-reinforced thermoplastic resin forming material according to the preceding items, wherein the reinforcing fiber bundle contained in the first component (I) or the second component (II) is made of a carbon fiber or a glass fiber.
[13] The fiber-reinforced thermoplastic resin forming material according to the preceding items, wherein the first component (I) and the second component (II) contain at least one of a group of resins including polypropylene resin, polyethylene resin, polycarbonate resin, polyamide resin, polyester resin, polyarylene sulfide resin, polyphenylene sulfide resin, polyether ketone, polyetheretherketone resin, polyether ketone ketone resin, polyether sulfone resin, polyimide resin, polyamide-imide resin, polyetherimide resin and polysulfone resin.
[14] The fiber-reinforced thermoplastic resin forming material according to the preceding items, wherein the laminate has a thickness of 1 mm or more.

We thus provide a fiber-reinforced thermoplastic resin forming material excellent in mechanical properties and formability of complicated shapes.

### BRIEF DESCRIPTION OF THE DRAWINGS

FIG. 1 is a schematic perspective view showing a laminate structure of our fiber-reinforced thermoplastic resin forming material.

FIG. 2 is a schematic perspective view showing another laminate structure of our fiber-reinforced thermoplastic resin forming material.

FIG. 3 is a schematic view showing a cutting angle of a reinforcing fiber bundle constituting our fiber-reinforced thermoplastic resin forming material.

FIG. 4 is a schematic view showing a cutting angle of another reinforcing fiber bundle constituting our fiber-reinforced thermoplastic resin forming material.

### EXPLANATION OF SYMBOLS

λ1: thermal conductivity
B2: product of density and specific heat
θ: cutting angle
A1,A2: aspect ratio
Wf1,Wf2: fiber weight content
Lf1,Lf2: average fiber length
n1,n2: average fiber number
D1,D2: average fiber bundle width
Q: ratio of Lf1 and Lf2
Vf1,Vf2: fiber volume content

### DETAILED DESCRIPTION

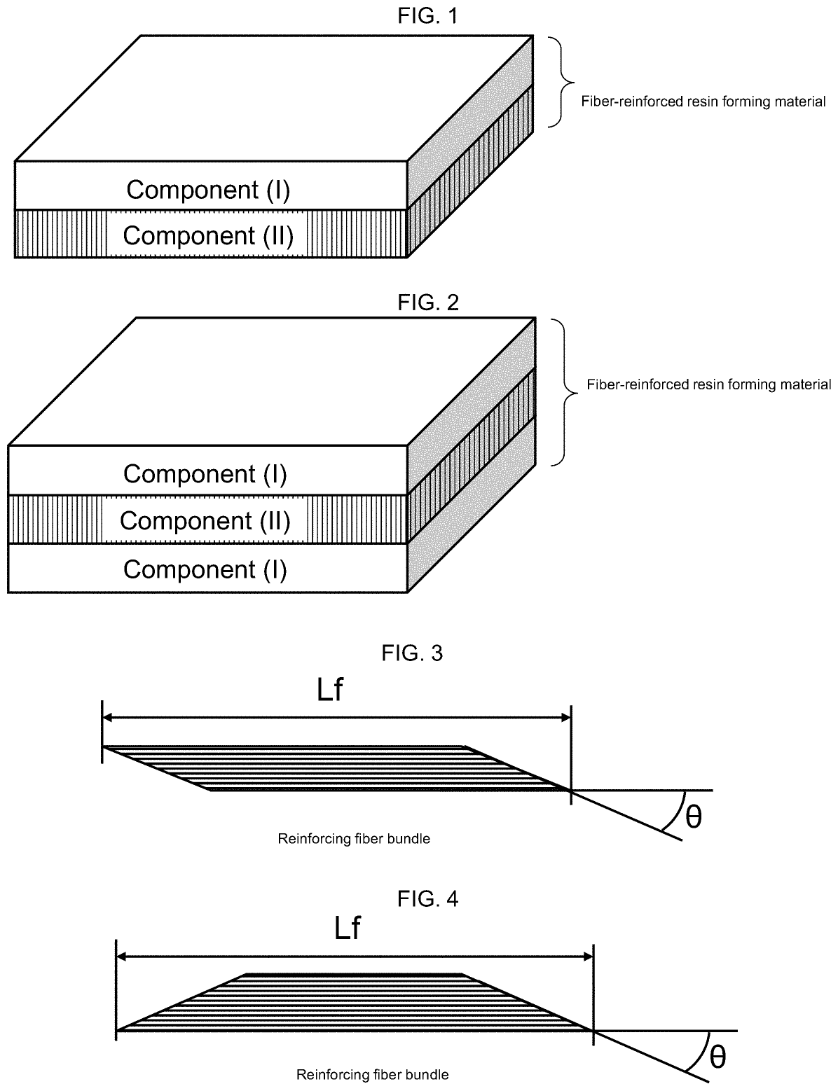

Our fiber-reinforced thermoplastic resin forming material is made by laminating component (I) and component (II) as shown in FIG. 1. Component (I) and components (II) may be or may not be integrated. Component (I) and component (II) comprise reinforcing fibers and thermoplastic resin.

Component (I) should exist on the surface of the laminate of component (I) and component (II). It is preferable that component (II) exists inside the laminate of which laminating order is shown as [component (I)/component (II)/component (I)]. The number of components constituting the laminate is not limited. It is preferable that the fiber-reinforced thermoplastic resin forming material includes component (II) of 50 vol % or more. It is preferable that the volume content is 60 vol % or more, further preferably 75 vol % or more. It is preferable that the volume content is 95 vol % or less. It is more preferably 90 vol % or less, further preferably 85 vol % or less.

It is preferable that component (I) has a thermal conductivity λ1 of 0.2 W/m·K or less as a value determined according to JIS R1611 (Measurement methods of thermal diffusivity, specific heat capacity, and thermal conductivity for fine ceramics by flash method). It is preferable that it is 0.15 W/m·K or less, further preferably 0.1 W/m·K or less. The thermal conductivity within the range can enhance the fluidity of fiber-reinforced thermoplastic resin forming material. It is practicable that component (I) has a thermal conductivity of 0.01 W/m·K or more.

It is preferable that component (I) has a void ratio of 5% or more. It is more preferable that it is 10% or more, further preferably 15% or more. The void ratio within the range can slow the cooling rate and enhance the fluidity of fiber-reinforced thermoplastic resin forming material. It is practicable that component (I) has a void ratio of 70% or less. The void ratio can be determined by a method to be described later.

It is preferable that component (II) has 1.7×10⁶ J/m³·K or more of product B2 of density and specific heat, where the density is determined according to JIS K7222:2005 (Cellular plastics and rubbers—Determination of apparent (bulk) density) and the specific heat is determined according to JIS R1611 (Measurement methods of thermal diffusivity, specific heat capacity, and thermal conductivity for fine ceramics by flash method). It is more preferable that it is 2×10⁶ J/m³·K or more, further preferably 2.5×10⁶ J/m³·K or more. The product within the range can slow the cooling rate and enhance the fluidity of fiber-reinforced thermoplastic resin forming material. It is practicable that component (II) has 5×10⁶ J/m³·K or less of the product of density and specific heat.

It is preferable that component (I) has fiber weight content Wf1 of 20 wt % or more. It is more preferable that it is 30 wt % or more, further preferably 40 wt % or more. The fiber weight content within the range can enhance the mechanical properties of fiber-reinforced thermoplastic resin forming material. It is practicable that component (I) has fiber weight content Wf1 of 80 wt % or less.

It is preferable that component (II) has fiber weight content Wf2 of 50 wt % or less. It is more preferable that it is 40 wt % or less, further preferably 30 wt % or less. The fiber weight content within the range can enhance the fluidity of fiber-reinforced thermoplastic resin forming material. It is practicable that component (II) has fiber weight content Wf2 of 5 wt % or more.

It is preferable that the fiber-reinforced thermoplastic resin forming material laminate of component (I) and component (II) has a thickness of 1 mm or more. It is more preferably 1.5 mm or more, further preferably 2 mm or more. The thickness within the range can enhance the mechanical properties and fluidity of fiber-reinforced thermoplastic resin forming material. It is practicable that the fiber-reinforced thermoplastic resin forming material has a thickness of 10 mm or less.

It is preferable that component (I) contains reinforcing fiber bundles (I) having average fiber number n1 of 5,000 or less. It is more preferably 1,000 or less, further preferably 500 or less. The average fiber number within the range can enhance the mechanical properties of fiber-reinforced thermoplastic resin forming material. It is practicable that reinforcing fiber bundles (I) have average fiber number n1 of 10 or more. The average fiber number can be determined by a method to be described later.

It is preferable that component (II) contains reinforcing fiber bundles (II) having average fiber number n2 of 500 or more. It is more preferably 1,000 or more, further preferably 5,000 or more. The average fiber number within the range can enhance the fluidity of fiber-reinforced thermoplastic resin forming material. It is practicable that reinforcing fiber bundles (II) have average fiber number n2 of 50,000 or less. It is preferable that the fiber bundle is preliminarily bundled. The condition of “preliminarily bundled” may be a condition of fibers bundled by interlacing yarns constituting the fiber bundle, a condition of fibers bundled by adding a sizing agent to the fiber bundle, or a condition of fibers bundled by giving a twist in the fiber bundle production process.

It is preferable that component (I) contains reinforcing fiber bundles (I) having aspect ratio A1 of 2 or more, where the aspect ratio A1 (A1=Lf1/D1) is defined as ratio A1 of average fiber length Lf1 [mm] and average fiber bundle width D1 [mm]. It is more preferable that aspect ratio A1 is 20 or more, further preferably 100 or more. The aspect ratio within the range can enhance the mechanical properties of fiber-reinforced thermoplastic resin forming material. It is practicable that reinforcing fiber bundles (I) have aspect ratio A1 of 200 or less. Average fiber length Lf1 [mm] and average fiber bundle width D1 [mm] can be determined by a method to be described later.

It is preferable that component (II) contains reinforcing fiber bundles (II) having aspect ratio A2 of 10 or less, where the aspect ratio A2 (A2=Lf2/D2) is defined as ratio A2 of average fiber length Lf2 [mm] and average fiber bundle width D2 [mm]. It is more preferable that aspect ratio A2 is 7 or less, further preferably 3 or less. The aspect ratio within the range can enhance the fluidity of fiber-reinforced thermoplastic resin forming material. It is practicable that reinforcing fiber bundles (II) have aspect ratio A2 of 0.1 or more. Average fiber length Lf2 [mm] and average fiber bundle width D2 [mm] can be determined by a method to be described later.

It is preferable that component (I) contains reinforcing fiber bundles (I) having average fiber length Lf1 of 8 mm or more. It is more preferably 12 mm or more, further preferably 15 mm or more. It is preferable that reinforcing fibers (I) have average fiber length Lf1 of 100 mm or less. It is more preferably 75 mm or less, further preferably 50 mm or less. The average fiber length within the range can enhance the mechanical properties.

It is preferable that component (II) contains reinforcing fiber bundles (II) having average fiber length Lf2 of 3 mm or more. It is more preferably 5 mm or more, further preferably 7 mm or more. It is preferable that reinforcing fibers (II) have average fiber length Lf2 of 20 mm or less. It is more preferably 15 mm or less, further preferably 10 mm or less. The average fiber length within the range can enhance the mechanical properties and fluidity of fiber-reinforced thermoplastic resin forming material.

It is preferable that ratio Q is 1 or more, where the ratio Q (=Lf1/Lf2) defined as a ratio of (average fiber length Lf1 [mm])/(average fiber length Lf2 [mm]). It is more preferably 2 or more, further preferably 3 or more. It is preferable that Q is less than 20. It is more preferably less than 10, further preferably less than 5. The ratio within the range can enhance the mechanical properties and fluidity of fiber-reinforced thermoplastic resin forming material.

It is possible to add a sizing agent for purposes such as prevention of reinforcing fibers from fluffing, improvement of reinforcing fiber bundles in bundling and improvement of matrix resin in adhesiveness. The sizing agents include a compound having a functional group such as epoxy group, urethane group, amino group and carboxyl group. One or more kinds of them can be added together. Such a sizing agent may be added in a production process of partially-separated fiber bundle to be described later.

It is preferable that the fiber bundle is preliminarily bundled. The condition of “preliminarily bundled” may be a condition of fibers bundled by interlacing yarns constituting the fiber bundle, a condition of fibers bundled by adding sizing agent to the fiber bundle, or a condition of fibers bundled by giving a twist in the fiber bundle production process.

It is preferable that the reinforcing fiber is made of carbon fiber, glass fiber, aramid fiber or metal fiber, although it is not limited thereto. Above all, it is preferably made of carbon fiber. From viewpoints of improvement of mechanical properties and lightweight of fiber-reinforced resin, it is preferable that the carbon fiber is based on polyacrylonitrile (PAN), pitch or rayon, although it is not limited in particular. It is possible that one or more kinds of the carbon fiber are used together. Above all, it is further preferable to use the PAN-based carbon fiber from a viewpoint of balance between strength and elastic modulus of fiber-reinforced resin obtained.

It is preferable that the reinforcing fibers have a single fiber diameter of 0.5 μm or more. It is more preferably 2 μm or more, further preferably 4 μm or more. Further, it is preferable that the reinforcing fibers have a single fiber diameter of 20 μm or less. It is more preferably 15 μm or less, further preferably 10 μm or less. It is preferable that the reinforcing fibers have a strand strength of 3.0 GPa or more. It is more preferably 4.0 GPa or more, further preferably 4.5 GPa or more. It is preferable that the reinforcing fibers have a strand elastic modulus of 200 GPa or more. It is preferably 220 GPa or more, further preferably 240 GPa or more. The strength and elastic modulus of strand within the range can enhance the mechanical properties of fiber-reinforced thermoplastic resin forming material.

It is preferable that the reinforcing fiber bundle constituting a random mat has a cutting angle θ shown in FIGS. 3 and 4 of 3° or more. It is more preferable that the cutting angle θ is 4° or more, further preferably 5° or more. The fiber bundles can stably be cut by the angle within the range. Further, it is preferable that the angle is 30° or less. It is more preferably 25° or less, further preferably 15° or less. The angle within the range can achieve both a good fluidity during the forming process and high mechanical properties of shaped product. Cutting angle θ should be a value of 0° to 90°.

It is preferable that the thermoplastic resin is polypropylene resin, polyethylene resin, polycarbonate resin, polyamide resin, polyester resin, polyarylene sulfide resin, polyphenylene sulfide resin, polyether ketone, polyetheretherketone resin, polyether ketone ketone resin, polyether sulfone resin, polyimide resin, polyamide-imide resin, polyetherimide resin, polysulfone resin, or a cyclic oligomer as a precursor thereof. It is possible to add an additive for the purpose of giving flexibility to resin.

### EXAMPLES

Hereinafter, our materials will be explained in detail with reference to Examples. Measurement methods, calculation methods and evaluation methods are as follows.

### Measurement Method of Fiber Volume Contents Vf1,Vf2 of Fiber-Reinforced Thermoplastic Resin Forming Material

A fiber-reinforced thermoplastic resin forming material is cut into a sample of approximately 2 g to be subject to a measurement of mass Wc0. The sample is heated for an hour in an electric furnace under nitrogen atmosphere (oxygen concentration is under 1%) at 500° C. to burn out organic substances such as matrix resin. After it is cooled down to room temperature, mass Wc1 of residual carbon fiber is measured to calculate the fiber volume contents by the following formula.

Vf1,Vf2 [vol %]=(Wc1/ρf)/{Wc1/ρf+(Wc0−Wc1)/ρr}×100

ρf: density [g/cm³] of reinforcing fiber
ρr: density [g/cm³] of thermoplastic resin

### Calculation Method of Void Ratio

The void ratio of sheet-shaped substance is calculated by the following formula from bulk density ρ0 (determined according to JIS K7222:2005 (Cellular plastics and rubbers —Determination of apparent (bulk) density)) and true density ρ1 (density of constitution material).

Void ratio=(1−ρ0/ρ1)×100

ρ0: bulk density [g/cm³]
ρ1: true density [g/cm³]={ρf×Vf1+ρr×(100−Vf1)}/100
Measurement Method of Average Fiber Numbers n1,n2 Per Bundle of Fiber-Reinforced Thermoplastic Resin Forming Material

The fiber-reinforced thermoplastic resin forming material is heated for an hour in an electric furnace under nitrogen atmosphere (oxygen concentration is under 1%) at 500° C. to burn out organic substances such as matrix resin, and then the fiber mat is taken out. Forty fiber bundles are picked up from thus obtained fiber mat to measure weight Wf [mg] of each bundle to calculate average fiber numbers n1,n2 per bundle by the following formula.

n1,n2=Wf/(ρf×πr²×Lf)×10⁶

ρf: density [g/cm³] of reinforcing fiber
r: fiber diameter [μm]
Lf: average fiber length [mm]

### Measurement Method of Average Fiber Lengths Lf1,Lf2

The fiber-reinforced thermoplastic resin forming material is heated for an hour in an electric furnace under nitrogen atmosphere (oxygen concentration is under 1%) at 500° C. to burn out organic substances such as matrix resin, and then the fiber mat is taken out. Forty fiber bundles are picked up from thus obtained fiber mat to calculate average fiber lengths Lf1,Lf2 as average values of the longest fiber lengths in the longitudinal direction of a fiber bundle.

### Measurement Method of Average Fiber Bundle Widths D1,D2

The fiber-reinforced thermoplastic resin forming material is heated for an hour in an electric furnace under nitrogen atmosphere (oxygen concentration is under 1%) at 500° C. to burn out organic substances such as matrix resin, and then the fiber mat is taken out. Forty fiber bundles are picked up from thus obtained fiber mat to calculate average fiber bundle widths D1,D2 as average values of the widest widths in the orthogonal direction of a fiber bundle.

### Measurement Method and Evaluation Method of Bending Strength

According to JIS K7074 (1988), the bending strength of fiber-reinforced thermoplastic resin forming material is measured. The bending strength is evaluated as: C for less than 200 MPa; B for 200 MPa or more and less than 350 MPa; and A for 350 MPa or more.

### Measurement Method and Evaluation Method of Rate of Flow R of Fiber-Reinforced Thermoplastic Resin Forming Material

Rate of flow R of fiber-reinforced thermoplastic resin forming material is determined according to the following procedure.

(1) A fiber-reinforced thermoplastic resin forming material is cut into a square size of 100 mm×100 mm.
(2) The fiber-reinforced thermoplastic resin forming material preheated at a predetermined temperature with an IR heater until the resin is melted.
(3) It is placed on a press board heated to a predetermined temperature and is pressurized at 20 MPa for 30 sec.
(4) Surface area S2 [mm²] of obtained shaped product and surface area S1 [mm²] of fiber-reinforced thermoplastic resin forming material before the pressing process are measured to calculate rate of flow R [%] by the formula of S2/S1×100. Rate of flow R is evaluated as: C for less than 200%; B for 200% or more and less than 300%; and A for 300% or more.

### Raw Materials

Reinforcing Fiber Bundle 1 (Carbon Fiber)

Carbon fiber bundle (“PX35” made by ZOLTEK company, single yarn number of 50,000) is used.

Reinforcing Fiber Bundle 2 (Glass Fiber)

Glass fiber bundle (240TEX made by Nitto Boseki Co., Ltd., single yarn number of 1,600) is used.

Resin Sheet 1 (Ny6)

Polyamide master batch made of polyamide 6 resin (made by Toray Industries, Inc., “Amilan” (registered trademark) CM1001) is used to prepare the sheet.

Resin Sheet 2 (PP)

Polypropylene master batch made of native polypropylene resin (made by Prime Polymer Co., Ltd., “Prime Polypro” (registered trademark) J106MG) of 90 mass % and acid-modified polypropylene resin (made by Mitsui Chemicals, Inc., “ADMER” (registered trademark) QE800) of 10 mass % is used to prepare the sheet.

### Production Method of Component

The fiber bundle rolled out by a winder constantly at 10 m/min is fed to a vibrational widening roller vibrating in the axial direction at 10 Hz to widen the width, and then fed to a 60 mm width regulation roller to make a widened fiber bundle having width of 60 mm.

Thus obtained widened fiber bundle is fed to a fiber separation means provided with iron plates for fiber separation having a protrusive shape of 0.2 mm thickness, 3 mm width and 20 mm height, the iron plates being set in parallel at regular intervals of 3.5 mm along the reinforcing fiber bundle width. The fiber separation means is intermittently inserted in and extracted from the widened fiber bundle to make a partially-separated fiber bundle.

The fiber separation means is kept for 3 sec as inserted in the widened fiber bundle travelling constantly at 10 m/min to generate a fiber separation section, and then kept for 0.2 sec as extracted therefrom. Such an insertion/extraction process is repeated.

The partially-separated fiber bundle has fiber separation sections in which fiber bundles are separated with respect to the width direction to have a target average fiber number. At least one end of a fiber separation section has an accumulated interlacing section in which interlaced single yarns are accumulated. Next, the partially-separated fiber bundles are continuously inserted into a rotary cutter to cut the bundles into a target fiber length, and then are sprayed to be uniformly to make a discontinuous fiber nonwoven fabric having an isotropic fiber orientation.

The discontinuous fiber nonwoven fabric sandwiched vertically by resin sheets is impregnated with the resin by a pressing machine to produce a sheet of fiber-reinforced thermoplastic resin forming material.

### Reference Example 1

The above-described production method was performed to prepare a fiber-reinforced thermoplastic resin forming material component (fiber weight content of 49 wt %, thermal conductivity of 0.07 W/m·K, void ratio of 50%, thickness of 0.4 mm) consisting of resin sheet 1 (Ny6) and discontinuous fiber nonwoven fabric which includes reinforcing fiber bundle 2 (glass fiber) having cutting angle of 10°, fiber length of 20 mm and average fiber number of 1,000, as shown in Table 1.

### Reference Example 2

The above-described production method was performed to prepare a fiber-reinforced thermoplastic resin forming material component (fiber weight content of 40 wt %, thermal conductivity of 0.1 W/m·K, void ratio of 50%, thickness of 0.4 mm) consisting of resin sheet 1 (Ny6) and discontinuous fiber nonwoven fabric which includes reinforcing fiber bundle 1 (carbon fiber) having cutting angle of 10°, fiber length of 20 mm and average fiber number of 1,000, as shown in Table 1.

### Reference Example 3

The above-described production method was performed to prepare a fiber-reinforced thermoplastic resin forming material component (fiber weight content of 22 wt %, thermal conductivity of 0.2 W/m·K, void ratio of 30%, thickness of 0.3 mm) consisting of resin sheet 1 (Ny6) and discontinuous fiber nonwoven fabric which includes reinforcing fiber bundle 1 (carbon fiber) having cutting angle of 50°, fiber length of 10 mm and average fiber number of 1,000, as shown in Table 1.

### Reference Example 4

The above-described production method was performed to prepare a fiber-reinforced thermoplastic resin forming material component (fiber weight content of 18 wt %, thermal conductivity of 0.2 W/m·K, void ratio of 30%, thickness of 0.3 mm) consisting of resin sheet 2 (PP) and discontinuous fiber nonwoven fabric which includes reinforcing fiber bundle 1 (carbon fiber) having cutting angle of 30°, fiber length of 10 mm and average fiber number of 1,000, as shown in Table 1.

### Reference Example 5

The above-described production method was performed to prepare a fiber-reinforced thermoplastic resin forming material component (fiber weight content of 26 wt %, thermal conductivity of 0.2 W/m·K, void ratio of 10%, thickness of 0.2 mm) consisting of resin sheet 2 (PP) and discontinuous fiber nonwoven fabric which includes reinforcing fiber bundle 1 (carbon fiber) having cutting angle of 30°, fiber length of 5 mm and average fiber number of 1,000, as shown in Table 1.

### Reference Example 6

The above-described production method was performed to prepare a fiber-reinforced thermoplastic resin forming material component (fiber weight content of 55 wt %, thermal conductivity of 0.3 W/m·K, void ratio of 1%, thickness of 0.2 mm) consisting of resin sheet 2 (PP) and discontinuous fiber nonwoven fabric which includes reinforcing fiber bundle 2 (glass fiber) having cutting angle of 10°, fiber length of 20 mm and average fiber number of 1,000, as shown in Table 1.

### Reference Example 7

The above-described production method was performed to prepare a fiber-reinforced thermoplastic resin forming material component (fiber weight content of 40 wt %, thermal conductivity of 0.5 W/m·K, void ratio of 1%, thickness of 0.2 mm) consisting of resin sheet 1 (Ny6) and discontinuous fiber nonwoven fabric which includes reinforcing fiber bundle 1 (carbon fiber) having cutting angle of 10°, fiber length of 20 mm and average fiber number of 1,000, as shown in Table 1.

### Reference Example 8

The above-described production method was performed to prepare a fiber-reinforced thermoplastic resin forming material component (fiber weight content of 49 wt %, product of density and specific heat of 2×10⁶ J/m³·K, thickness of 2 mm) consisting of resin sheet 1 (Ny6) and discontinuous fiber nonwoven fabric which includes reinforcing fiber bundle 2 (glass fiber) having cutting angle of 30°, fiber length of 10 mm and average fiber number of 1,000, as shown in Table 2.

### Reference Example 9

The above-described production method was performed to prepare a fiber-reinforced thermoplastic resin forming material component (fiber weight content of 46 wt %, product of density and specific heat of 2×10⁶ J/m³·K, thickness of 2 mm) consisting of resin sheet 2 (PP) and discontinuous fiber nonwoven fabric which includes reinforcing fiber bundle 1 (carbon fiber) having cutting angle of 50°, fiber length of 10 mm and average fiber number of 500, as shown in Table 2.

### Reference Example 10

The above-described production method was performed to prepare a fiber-reinforced thermoplastic resin forming material component (fiber weight content of 40 wt %, product of density and specific heat of 1.9×10⁶ J/m³·K, thickness of 2 mm) consisting of resin sheet 1 (Ny6) and discontinuous fiber nonwoven fabric which includes reinforcing fiber bundle 1 (carbon fiber) having cutting angle of 10°, fiber length of 8 mm and average fiber number of 3,000, as shown in Table 2.

### Reference Example 11

The above-described production method was performed to prepare a fiber-reinforced thermoplastic resin forming material component (fiber weight content of 40 wt %, product of density and specific heat of 1.9×10⁶ J/m³·K, thickness of 2 mm) consisting of resin sheet 1 (Ny6) and discontinuous fiber nonwoven fabric which includes reinforcing fiber bundle 1 (carbon fiber) having cutting angle of 10°, fiber length of 2 mm and average fiber number of 1,000, as shown in Table 2.

### Reference Example 12

The above-described production method was performed to prepare a fiber-reinforced thermoplastic resin forming material component (fiber weight content of 46 wt %, product of density and specific heat of 1.8×10⁶ J/m³·K, thickness of 2 mm) consisting of resin sheet 2 (PP) and discontinuous fiber nonwoven fabric which includes reinforcing fiber bundle 1 (carbon fiber) having cutting angle of 10°, fiber length of 30 mm and average fiber number of 500, as shown in Table 2.

### Reference Example 13

The above-described production method was performed to prepare a fiber-reinforced thermoplastic resin forming material component (fiber weight content of 46 wt %, product of density and specific heat of 1.8×10⁶ J/m³·K, thickness of 2 mm) consisting of resin sheet 2 (PP) and discontinuous fiber nonwoven fabric which includes reinforcing fiber bundle 1 (carbon fiber) having cutting angle of 10°, fiber length of 10 mm and average fiber number of 100, as shown in Table 2.

### Reference Example 14

The above-described production method was performed to prepare a fiber-reinforced thermoplastic resin forming material component (fiber weight content of 60 wt %, product of density and specific heat of 1.5×10⁶ J/m³·K, thickness of 2 mm) consisting of resin sheet 1 (Ny6) and discontinuous fiber nonwoven fabric which includes reinforcing fiber bundle 1 (carbon fiber) having cutting angle of 10°, fiber length of 10 mm and average fiber number of 1,000, as shown in Table 2.

### Example 1

Component (I) prepared in Reference Example 1 and component (II) prepared in Reference Example 8 were laminated to produce a fiber-reinforced thermoplastic resin forming material having laminate structure of [(I)/(II)/(II)/(I)] which may be expressed as [(I)/(II)₂/(I)] hereinafter. The fiber-reinforced thermoplastic resin forming material preheated at 280° C. was formed with thickness of 4.4 mm by a pressing machine. Table 3 shows the bending strength of shaped product and the rate of flow R of forming material.

### Example 2

Component (I) prepared in Reference Example 1 and component (II) prepared in Reference Example 10 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Example 3

Component (I) prepared in Reference Example 1 and component (II) prepared in Reference Example 11 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Example 4

Component (I) prepared in Reference Example 2 and component (II) prepared in Reference Example 8 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Example 5

Component (I) prepared in Reference Example 3 and component (II) prepared in Reference Example 8 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Example 6

Component (I) prepared in Reference Example 4 and component (II) prepared in Reference Example 9 were laminated to produce a fiber-reinforced thermoplastic resin forming material having laminate structure of [(I)/(II)₂/(I)]. The fiber-reinforced thermoplastic resin forming material preheated at 230° C. was formed with thickness of 4.4 mm by a pressing machine. Table 3 shows the bending strength of shaped product and the rate of flow R of forming material.

### Example 7

Component (I) prepared in Reference Example 4 and component (II) prepared in Reference Example 12 were laminated to produce a fiber-reinforced thermoplastic resin forming material having laminate structure of [(I)/(II)₂/(I)]. The fiber-reinforced thermoplastic resin forming material preheated at 230° C. was formed with thickness of 4.4 mm by a pressing machine. Table 3 shows the bending strength of shaped product and the rate of flow R of forming material.

### Example 8

Component (I) prepared in Reference Example 4 and component (II) prepared in Reference Example 13 were laminated to produce a fiber-reinforced thermoplastic resin forming material having laminate structure of [(I)/(II)₂/(I)]. The fiber-reinforced thermoplastic resin forming material preheated at 230° C. was formed with thickness of 4.4 mm by a pressing machine. Table 3 shows the bending strength of shaped product and the rate of flow R of forming material.

### Example 9

Component (I) prepared in Reference Example 5 and component (II) prepared in Reference Example 9 were laminated to produce a fiber-reinforced thermoplastic resin forming material having laminate structure of [(I)/(II)₂/(I)]. The fiber-reinforced thermoplastic resin forming material preheated at 230° C. was formed with thickness of 4.4 mm by a pressing machine. Table 3 shows the bending strength of shaped product and the rate of flow R of forming material.

### Comparative Example 1

Component (I) prepared in Reference Example 6 and component (II) prepared in Reference Example 9 were laminated to produce a fiber-reinforced thermoplastic resin forming material having laminate structure of [(I)/(II)₂/(I)]. The fiber-reinforced thermoplastic resin forming material preheated at 230° C. was formed with thickness of 4.4 mm by a pressing machine. Table 3 shows the bending strength of shaped product and the rate of flow R of forming material.

### Comparative Example 2

Component (I) prepared in Reference Example 7 and component (II) prepared in Reference Example 8 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Comparative Example 3

Component (I) prepared in Reference Example 1 and component (II) prepared in Reference Example 14 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Comparative Example 4

Component (I) prepared in Reference Example 1 and component (II) prepared in Reference Example 8 were laminated to produce a fiber-reinforced thermoplastic resin forming material having laminate structure of [(I)/(II)₂/(I)]. The fiber-reinforced thermoplastic resin forming material preheated at 280° C. was formed with thickness of 4.4 mm by a pressing machine. Table 3 shows the bending strength of shaped product and the rate of flow R of forming material.

### Comparative Example 5

Component (I) prepared in Reference Example 1 was laminated to produce a fiber-reinforced thermoplastic resin forming material having laminate structure of [(I)₂₀]. The fiber-reinforced thermoplastic resin forming material preheated at 280° C. was formed with thickness of 4 mm by a pressing machine. Table 3 shows the bending strength of shaped product and the rate of flow R of forming material.

### Comparative Example 6

Component (II) prepared in Reference Example 8 was laminated to produce a fiber-reinforced thermoplastic resin forming material having laminate structure of [(II)₂]. The fiber-reinforced thermoplastic resin forming material preheated at 280° C. was formed with thickness of 4 mm by a pressing machine. Table 3 shows the bending strength of shaped product and the rate of flow R of forming material.

TABLE 1

| | | | | | | Fiber weight | | | Average |
|---|---|---|---|---|---|---|---|---|---|
| | | | | | | content | Fiber | | fiber |
| | | | Thermal | | Cutting | before | length | Aspect | number |
| | Reinforcing | Resin | conductivity | Void | Angle | forming | Lfl | ratio | n1 |
| | fiber bundle | Sheet | λ1 W/m · K | ratio % | θ ° | Wf1 % | mm | Al | fibers |
| Reference Example 1 | Glass fiber | Ny6 | 0.07 | 50 | 10 | 49 | 20 | 20 | 1,000 |
| Reference Example 2 | Carbon fiber | Ny6 | 0.1 | 50 | 10 | 40 | 20 | 10 | 1,000 |
| Reference Example 3 | Carbon fiber | Ny6 | 0.2 | 30 | 50 | 22 | 10 | 10 | 1,000 |
| Reference Example 4 | Carbon fiber | PP | 0.2 | 30 | 30 | 18 | 10 | 5 | 1,000 |
| Reference Example 5 | Carbon fiber | PP | 0.2 | 10 | 30 | 26 | 5 | 20 | 1,000 |
| Reference Example 6 | Glass fiber | PP | 0.3 | 1 | 10 | 55 | 20 | 20 | 1,000 |
| Reference Example 7 | Carbon fiber | Ny6 | 0.5 | 1 | 10 | 40 | 20 | 0 | 1,000 |

TABLE 2

| | | | Product of | | Fiber weight | | | |
|---|---|---|---|---|---|---|---|---|
| | | | density and | | content | Fiber | | Average |
| | Reinforcing | | specific | Cutting | before | length | Aspect | fiber |
| | fiber | Resin | heat B2 | Angle | forming | Lf2 | ratio | number |
| | bundle | Sheet | 10⁶ J/m³ · K | θ ° | Wf2 % | mm | A2 | n2 fibers |
| Reference Example 8 | Glassfiber | Ny6 | 2 | 30 | 49.0 | 10 | 5 | 2,000 |
| Reference Example 9 | Carbon fiber | PP | 2 | 50 | 46.0 | 10 | 20 | 500 |
| Reference Example 10 | Carbon fiber | Ny6 | 1.9 | 10 | 40.0 | 8 | 3 | 3,000 |
| Reference Example 11 | Carbon fiber | Ny6 | 1.9 | 10 | 40.0 | 2 | 2 | 1,000 |
| Reference Example 12 | Carbon fiber | PP | 1.8 | 10 | 46.0 | 30 | 60 | 500 |
| Reference Example 13 | Carbon fiber | PP | 1.8 | 10 | 46.0 | 10 | 100 | 100 |
| Reference Example 14 | Carbon fiber | Ny6 | 1.5 | 10 | 60.0 | 10 | 10 | 1,000 |

TABLE 3

| | | | | | | | | Component (II) | | | | | | | | | Forming material | | | | | |
|---|---|---|---|---|---|---|---|---|---|---|---|---|---|---|---|---|---|---|---|---|---|---|
| | | | | | | | | | | | Product | | Fiber | | | Aver- | | | | Aver- | | |
| Component (I) | | | | | | | | | | | of | | weight | | | age | | Propor- | | age | | |
| | | | | Thermal | | | | | | | density | | content | | | fiber | | tion of | | fiber | | Shaped |
| | | Rein- | | conducti- | | Cut- | Fiber | | Rein- | | and | Cut- | before | Fiber | As- | num- | | compo- | | length | Rate | product |
| | | forcing | | vity | Void | ting | length | | forcing | | specific | ting | form- | length | pect | ber | | nent | Thick- | ratio | of | Bend- |
| | | fiber | | λ1 | ratio | angle | Lf1 | | fiber | | heat B2 | Angle | ing | Lf2 | ratio | n2 | Laminate | (II) | ness | Lf1/ | flow | ing |
| | | bundle | Resin | W/m · K | % | θ ° | mm | | bundle | Resin | 10⁶ J/m³ · K | θ ° | Wf2 % | mm | A2 | fibers | structure | % | mm | Lf2 | R | strength |
| Example 1 | Reference | Glass | Ny6 | 0.07 | 50 | 10 | 20 | Reference | Glass | Ny6 | 2 | 30 | 49 | 10 | 5 | 2,000 | [(I)/(II)₂/(I)] | 83 | 4.8 | 2.0 | A | B |
| | Example1 | fiber | | | | | | Example 8 | fiber | | | | | | | | | | | | | |
| Example 2 | Reference | Glass | Ny6 | 0.07 | 50 | 10 | 20 | Reference | Carbon | Ny6 | 1.9 | 10 | 40 | 8 | 3 | 3,000 | [(I)/(II)₂/(I)] | 83 | 4.8 | 2.5 | A | A |
| | Example 1 | fiber | | | | | | Example 10 | fiber | | | | | | | | | | | | | |
| Example 3 | Reference | Glass | Ny6 | 0.07 | 50 | 10 | 20 | Reference | Carbon | Ny6 | 1.9 | 10 | 40 | 2 | 2 | 1,000 | [(I)/(II)₂/(I)] | 83 | 4.8 | 10.0 | A | B |
| | Example 1 | fiber | | | | | | Example 11 | fiber | | | | | | | | | | | | | |
| Example 4 | Reference | Carbon | Ny6 | 0.1 | 50 | 10 | 20 | Reference | Glass | Ny6 | 2 | 30 | 49 | 10 | 5 | 2,000 | [(I)/(II)₂/(I)] | 83 | 4.8 | 2.0 | A | B |
| | Example 2 | fiber | | | | | | Example 8 | fiber | | | | | | | | | | | | | |
| Example 5 | Reference | Carbon | Ny6 | 0.2 | 30 | 50 | 10 | Reference | Glass | Ny6 | 2 | 30 | 49 | 10 | 5 | 2,000 | [(I)/(II)₂/(I)] | 88 | 4.6 | 1.0 | B | B |
| | Example 3 | fiber | | | | | | Example 8 | fiber | | | | | | | | | | | | | |
| Example 6 | Reference | Carbon | PP | 0.2 | 30 | 30 | 10 | Reference | Carbon | PP | 2 | 50 | 46 | 10 | 20 | 500 | [(I)/(II)₂/(I)] | 88 | 4.6 | 1.0 | B | B |
| | Example 4 | fiber | | | | | | Example 9 | fiber | | | | | | | | | | | | | |
| Example 7 | Reference | Carbon | PP | 0.2 | 30 | 30 | 10 | Reference | Carbon | PP | 1.8 | 10 | 46 | 30 | 60 | 500 | [(I)/(II)₂/(I)] | 88 | 4.6 | 0.3 | B | A |
| | Example 4 | fiber | | | | | | Example 12 | fiber | | | | | | | | | | | | | |
| Example 8 | Reference | Carbon | PP | 0.2 | 30 | 30 | 10 | Reference | Carbon | PP | 1.8 | 10 | 46 | 10 | 100 | 100 | [(I)/(II)₂/(I)] | 88 | 4.6 | 1.0 | B | A |
| | Example 4 | fiber | | | | | | Example 13 | fiber | | | | | | | | | | | | | |
| Example 9 | Reference | Carbon | PP | 0.2 | 10 | 30 | 5 | Reference | Carbon | PP | 2 | 50 | 46 | 10 | 20 | 500 | [(I)/(II)₂/(I)] | 90 | 4.4 | 0.5 | B | B |
| | Example 5 | fiber | | | | | | Example 9 | fiber | | | | | | | | | | | | | |
| Comparative | Reference | Glass | PP | 0.3 | 1 | 10 | 20 | Reference | Carbon | PP | 2 | 50 | 46 | 10 | 20 | 500 | [(I)/(II)₂/(I)] | 91 | 4.4 | 2.0 | C | B |
| Example 1 | Example 6 | fiber | | | | | | Example 9 | fiber | | | | | | | | | | | | | |
| Comparative | Reference | Carbon | Ny6 | 0.5 | 1 | 10 | 20 | Reference | Glass | Ny6 | 2 | 30 | 49 | 10 | 5 | 2,000 | [(I)/(II)₂/(I)] | 91 | 4.4 | 2.0 | C | B |
| Example 2 | Example 7 | fiber | | | | | | Example 8 | fiber | | | | | | | | | | | | | |
| Comparative | Reference | Glass | Ny6 | 0.07 | 50 | 10 | 20 | Reference | Carbon | Ny6 | 1.5 | 10 | 60 | 10 | 10 | 1,000 | [(I)/(II)₂/(I)] | 83 | 4.8 | 2.0 | C | A |
| Example 3 | Example 1 | fiber | | | | | | Example 14 | fiber | | | | | | | | | | | | | |
| Comparative | Reference | Glass | Ny6 | 0.07 | 50 | 10 | 20 | Reference | Glass | Ny6 | 2 | 30 | 49 | 10 | 5 | 2,000 | [(II)/(I)₂/(II)] | 83 | 4.8 | 2 | C | C |
| Example 4 | Example 1 | fiber | | | | | | Example 8 | fiber | | | | | | | | | | | | | |
| Comparative | Reference | Glass | Ny6 | 0.07 | 50 | 10 | 20 | | | | | | | | | | [(I)₂₀] | 0 | 4.0 | | A | C |
| Example 5 | Example 1 | fiber | | | | | | | | | | | | | | | | | | | | |
| Comparative | | | | | | | | Reference | Glass | Ny6 | 2 | 30 | 49 | 10 | 5 | 2,000 | [(II)₂] | 100 | 4.0 | | C | C |
| Example 6 | | | | | | | | Example 8 | fiber | | | | | | | | | | | | | |

### INDUSTRIAL APPLICATIONS

Our fiber-reinforced thermoplastic resin forming material is applicable to automotive interior/exterior, electric/electronic equipment housing, bicycle, airplane interior, box for transportation or the like.

1.-14. (canceled)

15. A fiber-reinforced thermoplastic resin forming material that contains reinforcing fiber bundles in a thermoplastic resin, wherein a laminate of a first component (I) and a second component (II) has a surface layer of the first component (I), wherein
the first component (I) is a sheet having a thermal conductivity (λ1) of 0.2 W/m·K or less,
the second component (II) is a fiber-reinforced thermoplastic resin sheet having a product (B2) of a density and a specific heat of 1.7×10⁶ J/m³·K or more.

16. The fiber-reinforced thermoplastic resin forming material according to claim 15, wherein the first component (I) has a void ratio of 5% or more.

17. The fiber-reinforced thermoplastic resin forming material according to claim 15, wherein the reinforcing fiber bundles have a cutting angle (θ) of 3° or more and 30° or less.

18. The fiber-reinforced thermoplastic resin forming material according to claim 15, wherein the reinforcing fiber bundles have an aspect ratio (A2) of 10 or less in the second component (II).

19. The fiber-reinforced thermoplastic resin forming material according to claim 15, wherein the first component (I) has a fiber weight content (Wf1) of 20 wt % or more.

20. The fiber-reinforced thermoplastic resin forming material according to claim 15, wherein the second component (II) has a proportion of 50 to 95 vol % with respect to a total volume of the first component (I) and the second component (II).

21. The fiber-reinforced thermoplastic resin forming material according to claim 15, wherein the reinforcing fiber bundles have an average fiber length (Lf1) of 8 mm or more and 100 mm or less in the first component (I).

22. The fiber-reinforced thermoplastic resin forming material according to claim 15, wherein the reinforcing fiber bundles have an average fiber length (Lf2) of 3 mm or more and 20 mm or less in the second component (II).

23. The fiber-reinforced thermoplastic resin forming material according to claim 15, wherein the second component (II) has a fiber weight content (Wf2) of 50 wt % or less.

24. The fiber-reinforced thermoplastic resin forming material according to claim 15, wherein the reinforcing fiber bundles have an average fiber number (n2) of 500 or more in the second component (II).

25. The fiber-reinforced thermoplastic resin forming material according to claim 15, wherein the laminate of the first component (I) and the second component (II) has a laminate structure of [(I)/(II)ₘ/(I)], where m is a positive integer.

26. The fiber-reinforced thermoplastic resin forming material according to claim 15, wherein the reinforcing fiber bundle contained in the first component (I) or the second component (II) is made of a carbon fiber or a glass fiber.

27. The fiber-reinforced thermoplastic resin forming material according to claim 15, wherein the first component (I) and the second component (II) contain at least one resin selected from the group consisting of polypropylene resin, polyethylene resin, polycarbonate resin, polyamide resin, polyester resin, polyarylene sulfide resin, polyphenylene sulfide resin, polyether ketone, polyetheretherketone resin, polyether ketone ketone resin, polyether sulfone resin, polyimide resin, polyamide-imide resin, polyetherimide resin and polysulfone resin.

28. The fiber-reinforced thermoplastic resin forming material according to claim 15, wherein the laminate has a thickness of 1 mm or more.
